(19) United States
(12) Patent Application Publication
(10) Pub. No.: US 2014/0251441 A1
(43) Pub. Date: Sep. 11, 2014

(54) FLOW ISOLATION SYSTEM

(71) Applicants: Jeffrey W. Smith, West Bountiful, UT (US); John DeMarco, West Bountiful, UT (US); Steven Arthur Ward, Kaysville, UT (US)

(72) Inventors: Jeffrey W. Smith, West Bountiful, UT (US); John DeMarco, West Bountiful, UT (US); Steven Arthur Ward, Kaysville, UT (US)

(21) Appl. No.: 14/202,705

(22) Filed: Mar. 10, 2014

Related U.S. Application Data
(60) Provisional application No. 61/774,839, filed on Mar. 8, 2013.

(51) Int. Cl. F16K 24/00

(52) U.S. Cl. CPC F16K 24/00
USPC 137/1; 137/596

(57) ABSTRACT

A flow isolation system for connecting a source of pressurized fluid to plumbing for using the fluid. A generally vertical flow chamber extends from a lower end to an upper end, with an inlet for a pressurized fluid is disposed in a sidewall of the vertical chamber in a position near but paced above the lower end, and an outlet disposed in a sidewall of the vertical chamber in a position near but below the upper end. An evacuation tube extends from an open end near the lower portion of the vertical chamber to an evacuation valve disposed in the upper end. A gas inlet may be disposed in the upper end. When both the exit and inlet are closed, the system may be evacuated by connecting pressurized gas to the gas inlet to force fluid up the evacuation tube and out the evacuation valve.

### CROSS-REFERENCE TO RELATED APPLICATION

This application claims the benefit of U.S. Provisional Application No. 61/774,839, filed Mar. 8, 2013, the disclosure of which is incorporated herein by reference in its entirety.

### TECHNICAL FIELD

The present disclosure relates to shutoffs and valves for waterlines and piping and more specifically to a flow isolation system.

### BACKGROUND

There are a significant number of applications where flow of a liquid or gas through a line system must be stopped or contained with a valve. Many times these valves are opened and closed several times during a day or remain open or closed for long periods of time. In many applications, flow can be inadvertently mixed or contaminated using one or more valves when one is closed after allowing a fluid or gas to flow through that valve followed by the opening of another valve. These valves are commonly used in any application which requires fluids to be conveyed in a line or pipe.

Typically, valves are used to temporarily stop the flow of liquids or gases. Some examples of these valves include: Ball valves, check valves, gate valves, solenoid valves, stop valve, globe valves, piston valves, diaphragm valves, butterfly valves, and the like. These valves have been used for decades and are very cost effective ways to stop or slow flow of liquids and gases. However, these valves typically merely stop flow and the liquid present in a pipe remains in place, which can lead to issues, including breakage due to freezing, etc.

One known way of dealing with this issue has been to use valves that are designed to be closed and then allow fluid on the low pressure side of the valve to be drained. This valve type, called a stop and waste valve (“SWV”), includes a “weep hole” which is open to the low pressure side of the valve in a closed position to allow fluid on that side to drain after the valve is closed. This can reduce the likelihood of the valve to freeze at low temperatures and thereby failure of the valve. However, a SWV may have limited usefulness for a number of applications.

Many applications require that a valve is closed and does not allow any further flow to prevent mixing or contamination of the fluid with the environment. Where a SWV stops the flow of a liquid such as water and then allows the low pressure side of the valve to drain the water out of a weep hole, it may not prevent such contamination. In one exemplary application, a SWV is used to connect culinary water to a home owner's sprinkler system. The intention is to prevent the connecting valve from failing if it freezes during the winter time. The SWV can accomplish this by allowing the water on the low pressure side to drain through the weep hole, reducing the chances of a failure as the result of water expanding during freezing, thereby cracking the valve and then allowing leakage into the surroundings. To further reduce this freezing risk, the SWV may be buried deep underground below the frost line, making it difficult to access for repair or replacement. However, water that has seeped out of the SWV stays around the valve and maintains a fluid path to the water inside the valve. When the valve is reopened, contamination on the high pressure water side of the valve may then be contaminated if a backflow condition arises.

Because of the contamination concerns, cities in the United States have outlawed or stopped the use of SWV to connect culinary water to irrigation systems to reduce the likelihood that a drinking water system becomes contaminated. Such contamination could cause illness among the population using the water. However, where a city does not allow SWV usage and conventional gate valves are used and are subject to wintertime freeze and potential failure. Where this happens, the homeowner must pay to have the valve excavated and repaired. Additionally, the problem of water contamination is not averted if a backflow condition arises before the failed gate valve is noticed and replaced. Thus, both the city and homeowners may pay extensive costs each year without reaching the desired result.

An apparatus or system that allowed for isolation and drainage of a connection without the use of a weephole would be an improvement in the art. Such a system that allowed for a drainable connection to an irrigation system to be made from culinary water, which could be drained for winter while preventing potentially contaminating backflow would be a further improvement in the art.

### SUMMARY

The present disclosure is directed to a flow isolation system for connecting a source of pressurized fluid to plumbing for using the fluid. A generally vertical flow chamber extends from a lower end to an upper end, with an inlet for a pressurized fluid disposed in a sidewall of the vertical chamber in a position near but placed above the lower end, and an outlet disposed in a sidewall of the vertical chamber in a position near but below the upper end. An evacuation tube extends from an open end near the lower portion of the vertical chamber to an evacuation valve disposed in the upper end. A gas inlet is also disposed in the upper end.

For use, the inlet may be connected to a source of pressurized fluid, such as a culinary water supply, and the outlet to plumbing for using the fluid, such as a sprinkling system, by standard shutoff valves. When the plumbing for using the system is in use, both valves are open and fluid flow through the inlet up the vertical chamber and out the outlet. To isolate the plumbing for using the fluid from the source and evacuation the system, both shutoff valves are closed preventing flow through the outlet or inlet. The evacuation valve is opened and a pressurized gas having a lower density than the fluid (for example, air is used where the fluid is water) may be placed into the vertical chamber through the gas inlet to displace the fluid in the chamber, thereby forcing fluid up the evacuation tube and out through the evacuation valve.

### DESCRIPTION OF THE DRAWINGS

It will be appreciated by those of ordinary skill in the art that the various drawings are for illustrative purposes only. The nature of the present disclosure, as well as other embodiments, may be more clearly understood by reference to the following detailed description, to the appended claims, and to the several drawings.

FIG. 1 is a cross sectional side view of a first embodiment of a system in accordance with the principles of the present disclosure depicting a fluid flow path therethrough.

FIG. 2 is a cross sectional view of the embodiment of FIG. 1 with the flow path closed depicting evacuation of the system.

FIG. 3 is a perspective view of the upper end of the system of FIG. 1.

FIG. 4 is a cross sectional side view of a second embodiment of a system in accordance with the principles of the present disclosure which may be useful as a fire hydrant, depicting a fluid flow path therethrough.

### DETAILED DESCRIPTION

It will be appreciated by those skilled in the art that the embodiments herein described, while illustrative, are not intended to so limit the scope of the appended claims. Those skilled in the art will also understand that various combinations or modifications of the embodiments presented herein can be made without departing from the scope of this disclosure. All such alternate embodiments are within the scope of the appended claims.

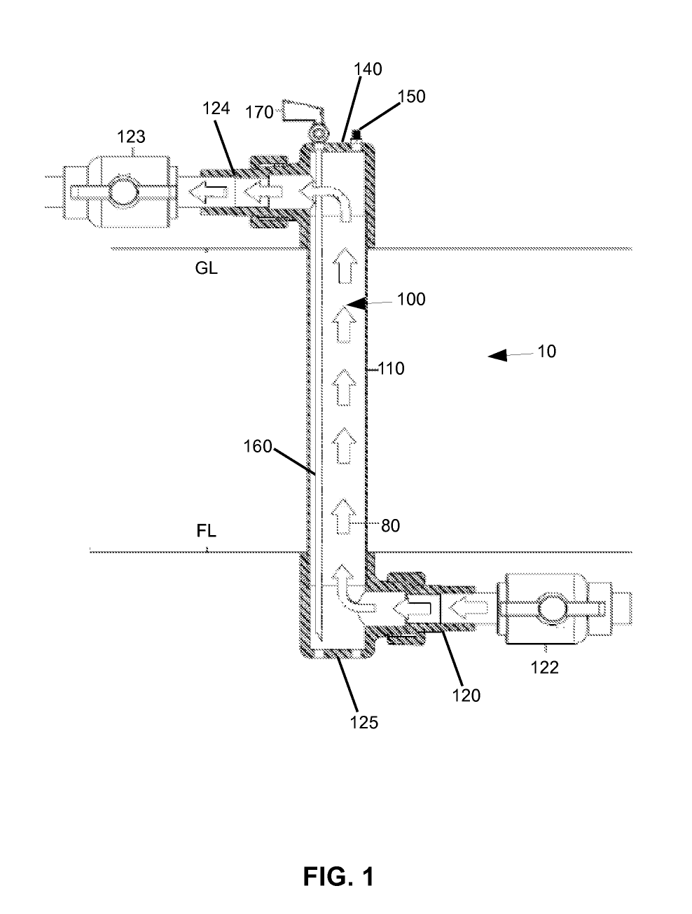

Referring to the drawing figures, FIG. 1 depicts a first embodiment of a system 10 in accordance with the present disclosure. In the depicted embodiment, the system 10 is used to connect a source of pressurized water, such as a municipal culinary water system, to a sprinkling system. It will be appreciated that other usages for such systems are contemplated, such as process piping, etc.

For use with a sprinkling system, a flow isolation system 10 may be installed with at least a portion of the vertical chamber 100 under ground level GL, and the lower end 130 and inlet 120 below the frost line FL.

As depicted, the generally vertical flow chamber 100 extends from a lower end 125 to an upper end 140, with an inlet 120 for a pressurized fluid disposed in a sidewall 110 of the vertical chamber 100 in a position near but placed above the lower end 130, and an outlet 124 disposed in the sidewall 110 of the vertical chamber 100 in a position near but below the upper end 140. It will be appreciated that although depicted facing away from each other, inlet 120 and outlet 124 may be placed facing the same direction or at any angle with respect to one another desired for a particular installation. It will be appreciated that flow chamber 100 may be a generally vertical chamber having a generally cylindrical cross-sectional shape, such as a pipe. However, other shapes may be used as may be desirable for particular installations.

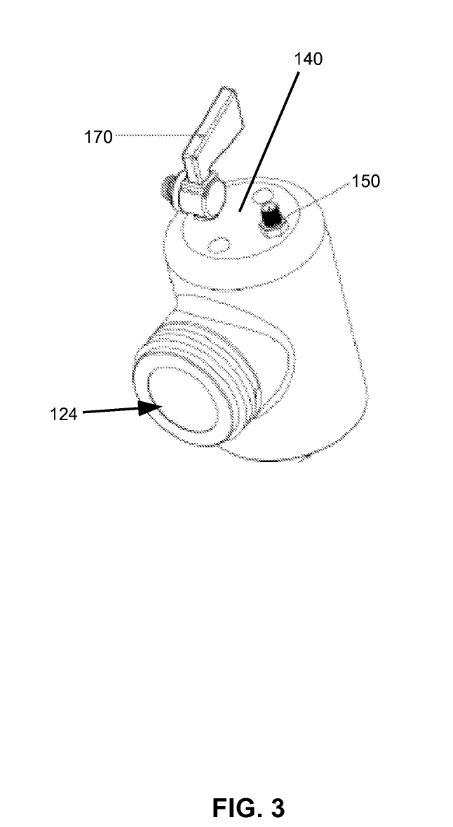

An evacuation tube 160 extends from an open end near the lower portion of the vertical chamber 100 to an evacuation valve 170 disposed in the upper end 140. A gas inlet 150 is also disposed in the upper end 140. In the depicted embodiment, the gas inlet 150 is a Schrader valve for accepting pressurized air, similar to those used on automotive wheels. It will be appreciated that other suitable valves may be used, depending on the size and planned usage of a system 10. The upper end 140 is best depicted in FIG. 3 in isolation.

For use, the inlet 120 may be connected to a source of pressurized fluid, such as a culinary water supply, and the outlet 124 to plumbing for using the fluid, such as a sprinkling system, by standard shutoff valves (122 and 123, respectively), which may be gate valves, ball valves or other shutoff valves as known in the art. When the plumbing for using the system is in use, both valves 122 and 123 are open and fluid flows through the inlet up the vertical chamber and out the outlet as indicated by arrows 80.

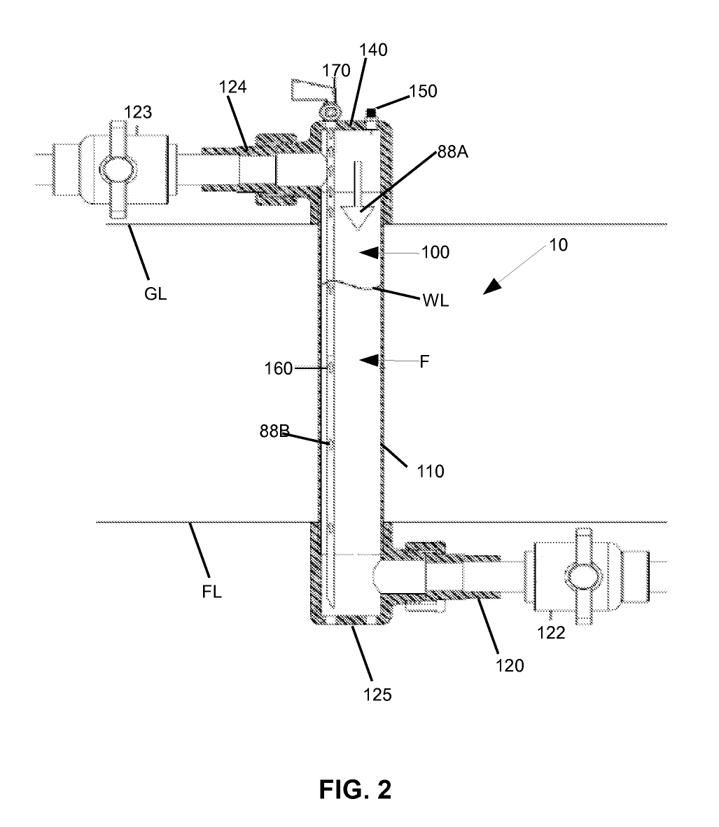

Turning to FIG. 2, evacuation of system 10 is depicted. First, to isolate the plumbing for using the fluid from the source and evacuate the system 10, both valves 122 and 123 are closed preventing flow through the outlet 124 or inlet 120. The evacuation valve 170 is opened and a pressurized gas having a lower density than the fluid (in this case air from an air compressor) is placed into the vertical chamber 100 through the gas inlet 140 to displace the fluid generally indicated at F in the chamber. As pressure is placed on fluid F, it is displaced and the upper line WL of the fluid F moves downwards as the fluid is forced up the evacuation tube 160 and out through the evacuation valve 170, as indicated by arrows 88A and 88B. The evacuation valve 170 may be connected to tubing for directing the evacuated fluid F away from the system 100 or for collecting the fluid F. As best depicted in FIG. 3, the evacuation valve 170 may include a threaded outlet for connection to such tubing.

It will be appreciated that the injected gas acts by displacement and thus may be introduced at relatively low pressures, which can extend the life of the system 10 by preventing potential failure. For example, in the depicted embodiment, air can be injected at a pressure of 40 psi or less to displace water.

It will be appreciated that evacuation tube 160 must be constructed from a material with sufficient rigidity to prevent collapse during the injection of pressurized gas into the chamber 100 through the gas inlet 140. For use with culinary water and sprinkling systems, the majority of the system may be constructed from a suitable polymer, such as PVC tubing. Given the low air pressures required to evacuate the chamber 10 when used with a culinary water system, a relatively flexible tubing, such as PEX tubing of a small diameter may be used. For example, with system 10 similar to the depicted embodiment, where the vertical chamber 100 may be formed from a PVC pipe having a diameter of about 2 inches, a PEX tubing of about ¼inch diameter may be used. It will be appreciated that these examples are only illustrative and other sizes may be used as desired for particular installations. The evacuation valve 170 and air inlet 150 may require construction with other suitable materials. For other uses, other materials may be required depending on the properties of the pressurized fluid and the size of the installation. By use of plastic materials for irrigation usage, the system may be constructed at a cost near or below that of standard stop and waste valves.

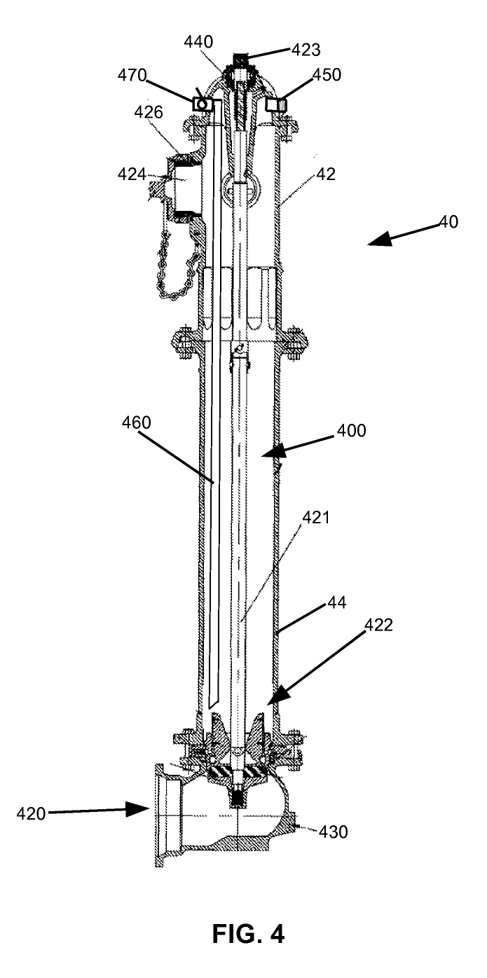

FIG. 4 depicts a second embodiment of a system 40 in accordance with the present disclosure is depicted. In the depicted embodiment, the system 40 is constructed as a fire hydrant which may be used to connect a source of pressurized water, such as a municipal culinary water system, to appropriate water delivery devices. Prior art fire hydrants typically include a weep hole for allowing drainage of the hydrant following use. This can lead to similar issues with backflow conditions as with a stop and waste valve and can also lead to stagnant or tainted water sitting in hydrants leading to corrosion and other issues. Incorporating a system 40 in accordance with this disclosure into a hydrant can reduce or eliminate this problem.

For use as a portion of the fire hydrant, the system 40, the “barrel” of the hydrant, including the upper nozzle section 42 and one or more standpipes 44 may function as a vertical chamber 400 of the flow isolation system 40. The lower portion of the vertical chamber 400 ends at a closed bottom containing a valve generally indicated at 422 which is disposed above hydrant bottom 430 and inlet 420, and is installed under ground level with the valve 422, lower end 430 and inlet 420 below the frost line. A sectional stem 421 extends from valve 422 to a head 421 at upper end 440 to allow it to be opened.

As depicted, the generally vertical flow chamber 400 extends from the closed bottom at valve 422 to an upper end 440, with an outlet 424 formed by the nozzle disposed in the sidewall 410 of the vertical chamber 400 in a position near but below the upper end 440.

An evacuation tube 460 extends from an open end near the lower portion of the vertical chamber 400 to an evacuation valve 470 disposed in the upper end 440. The evacuation tube 460 may be constructed from a suitable material to comply with installation requirements and be sized for efficient evacuation of the system 40. A gas inlet 450 is also disposed in the upper end 440. In the depicted embodiment, the gas inlet 450 is a Schrader valve for accepting pressurized air, similar to those used on automotive wheels. It will be appreciated that other suitable valves may be used, depending on the size and planned usage of a system 10. For example, a proprietary air intake valve having a different interconnect may be used to discourage tampering with the hydrant.

When installed, the inlet 420 will be connected to a source of pressurized fluid, such as a culinary water supply, and the outlet 424 may be closed by a removable cap 426. When the hydrant is in use, the cap 426 is removed and valve 422 is open and fluid flows through the inlet up the vertical chamber and out the outlet.

Following use, the chamber 400 of system 40 may be evacuated. First, valve 422 is closed preventing flow of pressurized fluid into the vertical chamber 400. Cap 426 is then installed to close outlet 424 and isolate and seal the chamber 400. The evacuation valve 470 may then be opened and a pressurized gas having a lower density than the fluid (in this case air from an air compressor) is placed into the vertical chamber 400 through the gas inlet 440 to displace the fluid in the chamber. As pressure is placed on fluid it is forced up the evacuation tube 460 and out through the evacuation valve 470. Once the chamber 400 has been evacuated, the valve 470 may be closed. As described, such a system 40 may allow a hydrant to be evacuated without the use of a weep hole.

While this disclosure has been described using certain illustrative embodiments, it will be appreciated that further modifications are within the spirit and scope of this disclosure. This application is therefore intended to cover any variations, uses, or adaptations of the invention using its general principles. Further, this application is intended to cover such departures from the present disclosure as come within known or customary practices in the art and which fall within the limits of the appended claims.

What is claimed is:

1. A flow isolation system for connecting a source of pressurized fluid to plumbing, comprising:
a flow chamber extending from a lower end to an upper end;
an inlet for a pressurized fluid to flow into a lower portion of the flow chamber;
an outlet for the pressurized fluid to flow from the flow chamber placed above the inlet;
an evacuation valve disposed near the upper end of the flow chamber;
an evacuation tube extending from an open end near the lower portion of the flow to the evacuation valve; and
a gas inlet for introducing gas into the flow chamber.

2. The flow isolation system of claim 1, wherein the flow chamber is a generally vertical chamber having a generally cylindrical cross-sectional shape.

3. The flow isolation system of claim 2, wherein the flow chamber comprises the barrel of a fire hydrant.

4. The flow isolation system of claim 1, further comprising a shut off valve for closing the inlet for pressurized fluid.

5. The flow isolation system of claim 1, further comprising a shut off valve for closing the outlet for the pressurized fluid.

6. The flow isolation system of claim 1, wherein the gas inlet comprises a Schrader valve.

7. The flow isolation system of claim 1, wherein the evacuation tube comprises PEX tubing.

8. The flow isolation system of claim 1, wherein the flow chamber is constructed from PVC pipe.

9. A method of draining a flow isolation system connecting a source of pressurized fluid to plumbing, comprising:
closing an inlet for a pressurized fluid to flow into a lower portion of a flow chamber to prevent pressurized fluid from entering the flow chamber;
closing an outlet for the pressurized fluid to flow from the flow chamber to prevent fluid flow from the flow chamber to isolate fluid within the flow chamber;
opening an evacuation valve disposed near an upper end of the flow chamber; and
introducing a gas into the flow chamber through a gas inlet disposed near the upper end of the flow chamber to displace the isolated fluid thereby forcing the isolated fluid to flow upwards through an evacuation tube extending from an open end near a lower portion of the flow chamber to the evacuation valve and out through the open evacuation valve.

10. The method according to claim 9, wherein closing an inlet for a pressurized fluid to flow into a lower portion of a flow chamber to prevent pressurized fluid from entering the flow chamber comprises closing a shutoff valve to isolate the flow chamber from a source of pressurized fluid.

11. The method according to claim 9, wherein closing an outlet for the pressurized fluid to flow from the flow chamber to prevent fluid flow from the flow chamber to isolate fluid within the flow chamber comprises closing a shutoff valve to prevent pressurized fluid from flowing from the flow chamber to a system for using the fluid.

12. The method according to claim 9, wherein closing an outlet for the pressurized fluid to flow from the flow chamber to prevent fluid flow from the flow chamber to isolate fluid within the flow chamber comprises sealing a removable cap over the outlet.

13. The method according to claim 9, further comprising attaching a bleed line to the evacuation valve disposed near an upper end of the flow chamber before opening the evacuation valve.

14. The method according to claim 13, further comprising collecting the isolated fluid flowing from the evacuation valve.

15. The method according to claim 9, wherein introducing a gas into the flow chamber through a gas inlet disposed near the upper end of the flow chamber to displace the isolated fluid thereby forcing the isolated fluid to flow upwards through an evacuation tube extending from an open end near a lower portion of the flow chamber to the evacuation valve and out through the open evacuation valve comprises introducing a gas through a Schrader valve disposed near the upper end of the flow chamber.

16. The method according to claim 9, wherein introducing a gas into the flow chamber through a gas inlet disposed near the upper end of the flow chamber to displace the isolated fluid thereby forcing the isolated fluid to flow upwards through an evacuation tube extending from an open end near a lower portion of the flow chamber to the evacuation valve and out through the open evacuation valve comprises introducing a gas at a pressure of about 40 PSI or less.

17. The method according to claim 9, wherein introducing a gas into the flow chamber through a gas inlet disposed near the upper end of the flow chamber comprises introducing air through the gas inlet.

18. The method according to claim 9, wherein forcing the isolated fluid to flow upwards through an evacuation tube extending from an open end near a lower portion of the flow chamber to the evacuation valve and out through the open evacuation valve comprises forcing water to flow upwards through an evacuation tube extending from an open end near a lower portion of the flow chamber to the evacuation valve and out through the open evacuation valve.

19. The method according to claim 9, wherein the flow chamber is a generally vertical chamber having a generally cylindrical cross-sectional shape.

20. The method according to claim 19, wherein the flow chamber comprises the barrel of a fire hydrant.
